(19) United States
(12) Patent Application Publication
(10) Pub. No.: US 2017/0210283 A1
(43) Pub. Date: Jul. 27, 2017

(54) DISPLAY DEVICE OF OPERATION STATE OF AUTOMOBILE BRAKE

(71) Applicant: Mitsunori Ishida, Tokyo (JP)

(72) Inventor: Mitsunori Ishida, Tokyo (JP)

(21) Appl. No.: 15/004,001

(22) Filed: Jan. 22, 2016

(51) Int. Cl. B60Q 1/44

(52) U.S. Cl. CPC B60Q 1/442

(57) ABSTRACT

[OBJECT] To clearly awaken a pedestrian who crosses in front of an automobile to the fact that an automobile driver is depressing a brake pedal.

[ACHIEVING MEANS] The invention is a display device of operation state of automobile brake that includes a brake operation detection switch (Bp) and a light emitting device (2). The brake operation detection switch (Bp) is actuated by depressing a brake pedal (3) and outputs a brake actuating signal to the light emitting device (2). The light emitting device (2) is disposed on an undersurface of a front of an automobile body (1), and emits diffused light in a fixed range of the front of the automobile body by receiving an input of the brake actuating signal so that the diffused light forms an optical projection image (Pi) on a road within a range of a shadow of the automobile body (1) as a caution arousing sign. Apedestrian looks at the opticalprojection image (Pi) displayed in the shadow (1a) of the automobile body (1), and ascertains that a brake operation is being performed, thus enabling the pedestrian to cross a pedestrian crossing at ease.

### TECHNICAL FIELD

The present invention relates to a device that displays an operation state of an automobile brake.

### BACKGROUND ART

A brake lamp of an automobile is disposed at the rear of an automobile body in order to avoid being struck from behind. To alert another automobile there behind, a red luminous color is used. The brake lamp is usually used together with a back light, and the reason why a redly luminous lamp is used as the back light is that a caution-arousing display is made to alert a following automobile there behind or to alert pedestrians. As thus described, an automobile is provided with a caution-arousing lamp at its rear part.

However, for example, when a pedestrian attempts to cross a road in front of an automobile at a place without a traffic light machine, whether the automobile stops while giving careful caution to the pedestrian or whether the automobile continues to stop without starting during the stopping of the automobile cannot be understood by merely seeing the automobile. There is a case in which the automobile starts without noticing the pedestrian because of the carelessness of a driver of the automobile even if the automobile is stopped, and there is a danger that a serious accident will be caused if the driver is slow to become aware of the pedestrian.

To solve this problem, Patent Document 1 discloses a method for enabling a pedestrian to notice that an automobile is going forward without providing an unpleasant feeling to the pedestrian by projecting a laser beam to a road surface in front of the pedestrian with the thought that a warning needs to be issued to the pedestrian according to ways other than an alarming horn.

The method disclosed by Patent Document 1 is, in brief, to brightly illuminate the road surface in front of the pedestrian at which a physical object exists in the detection range of a forward sensor mounted on the automobile and to warn the pedestrian so as to notice that the automobile is approaching the pedestrian. However, the time that makes it possible to brightly illuminate the road surface in front of the pedestrian by projecting a laser beam is limited to nighttime, and it is difficult to make the pedestrian notice a warning even if a laser beam is projected during the daytime during which the environment around the pedestrian is bright.

Additionally, even if it becomes possible to brightly illuminate the road surface in front of the pedestrian with a laser beam when the forward sensor is used in the nighttime, a laser beam, instead of an alarm whistle, is merely projected to illuminate it, and, even when the automobile is stopped, it is impossible to determine whether the automobile is stopped in a state of being ready to start at any time or whether there is a danger that the automobile will suddenly start.

### PRIOR ART DOCUMENTS

### Patent Documents

[Patent Document 1] Japanese Published Unexamined Patent Application No. 2013-124092

### SUMMARY OF THE INVENTION

### Problems to be Solved by the Invention

Problems to be solved reside not only in that the time that makes it possible to brightly illuminate the road surface in front of the pedestrian by projecting a laser beam forwardly from the automobile is limited to nighttime but also in that it is impossible for a pedestrian who attempts to cross in front of a stopped automobile to determine whether the automobile is stopped while an automobile driver applies the brake or whether there is a danger that the automobile will suddenly start.

### Means for Solving the Problems

The present invention is a device that enables a pedestrian to recognize that an automobile driver is applying a brake and to safely cross in front of an automobile by projecting diffused light from an automobile body onto a fixed range directly under the automobile body when the automobile is stopped by applying the brake or when the automobile is decelerated by applying the brake while traveling, and by forming an optical projection image within the shadow of the automobile on a road, and by allowing the pedestrian to look at the optical projection image.

### Effects of the Invention

According to the present invention, an optical projection image is formed within the shadow of the automobile body directly under the automobile body of the front of the automobile, and therefore the projection image makes it possible for the pedestrian to easily determine whether the automobile is stopped by applying the brake, and makes it possible for the pedestrian to safely cross in front of the automobile while looking at the optical projection image.

Additionally, according to the present invention, an optical projection image is formed within the shadow of the automobile body directly under the automobile body of the front of the automobile, and therefore there is no problem about forming an optical projection image even when the sun is directly above the automobile in the daytime, to say nothing of nighttime, and any problems are never caused in forming an optical projection image even if a road surface onto which the image is projected is in a rugged state. Or rather, the distinction between brightness and darkness becomes clearer in proportion to an increase in intensity of sunlight, and it is possible to more clearly express an optical projection image projected into the shadow of the automobile body. Characters, figures, patterns, symbols, etc., may be included in the optical projection image.

Still additionally, according to the present invention, a brake state of a following automobile behind the automobile is displayed on a driving mirror of the automobile, and therefore it is possible to perceive the presence or absence of the danger of a rear-end collision accident caused by the following automobile.

As is clear, when specific consideration is given to any part of an automobile gazed by a pedestrian when the pedestrian attempts to cross in front of the automobile, the reaction of the pedestrian that can convince all people is that the pedestrian recognizes the size of the automobile first, and then a pedestrian's gaze is directed toward a lower part below the center of the automobile.

In other words, if pedestrian's eyes are freely turned upon a shadow part directly under the automobile body, a projection image of a laser beam projected into the shadow of the automobile body will be inevitably recognized, and the presence or absence of the projection image makes it possible to provide the pedestrian with information about whether the automobile is being stopped while the brake is being applied, and it is possible to provide the pedestrian with information that enables the pedestrian to predict the action of a driver if the automobile is an automatic automobile and makes a display showing the fact that a gearshift has been put into any one of a parking range, a reverse range, a neutral range, and a drive range in addition to the fact that the brake is being applied.

### BRIEF DESCRIPTION OF THE DRAWINGS

FIG. 1a is a view showing an embodiment of the present invention. FIG. 1b is a view showing an example of an optical projection image formed as a caution arousing sign on a road within the range of the shadow of an automobile body.

FIG. 2 is an electric wiring diagram of a brake operation detection switch Bp.

FIG. 3 is a perspective view showing an optical projection image formed in the shadow of the automobile.

FIG. 4 is a view showing another embodiment of the present invention.

FIG. 5 is a view showing an example of an optical projection image that is reflected in a driving mirror of the automobile and that is emitted by a following automobile.

### MODES FOR CARRYING OUT THE INVENTION

The present invention is a device that emits diffused light from a light emitting device disposed on the undersurface of the front of an automobile body in a fixed range of the front of the automobile body by depressing a brake pedal and that forms an optical projection image as a caution arousing sign on a road within the range of the shadow of the automobile body.

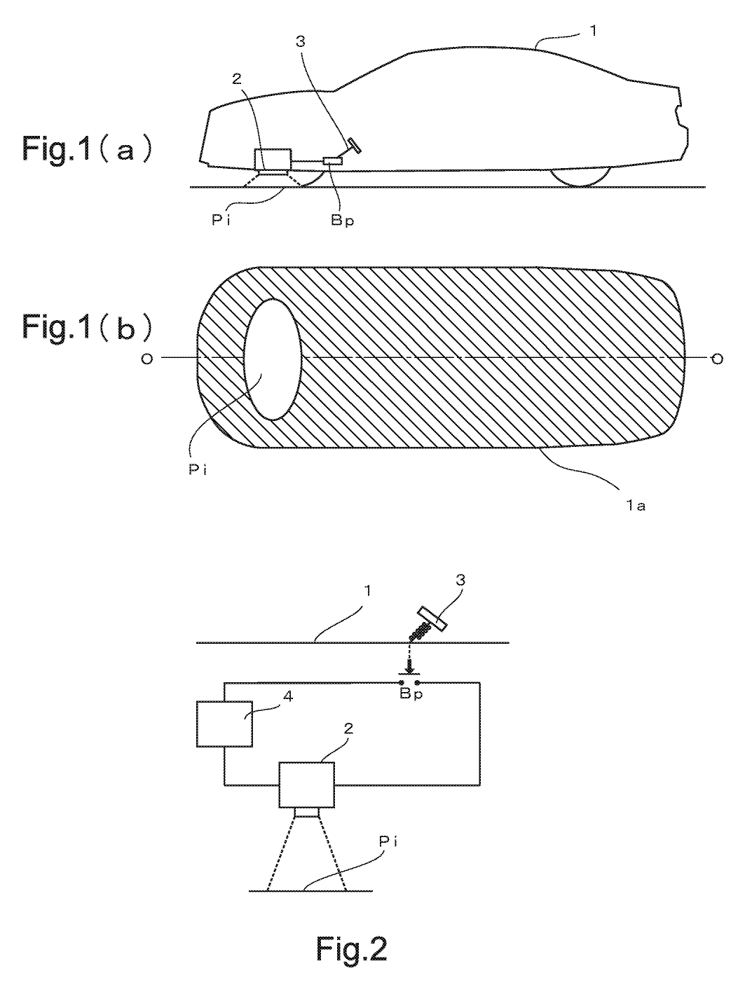

A concrete arrangement will be described in detail with reference to drawings. FIG. 1a is a view showing a basic structure of the present invention. In FIG. 1a, the display device of operation state of automobile brake according to the present invention includes a brake operation detection switch Bp and a light emitting device 2. The brake operation detection switch Bp is operated by depressing a brake pedal 3, and outputs a brake actuating signal to the light emitting device 2. The light emitting device 2 is disposed on the undersurface of the front of an automobile body 1, and emits diffused light in a fixed range of the front of the automobile body by receiving the input of the brake actuating signal, and, as shown in FIG. 1b, forms an optical projection image Pi as a caution arousing sign on the road within the range of a shadow 1a of the automobile body 1. An electric wiring diagram of the brake operation detection switch Bp is shown in FIG. 2.

In short, the brake operation detection switch Bp outputs a brake actuating signal to the light emitting device 2 while using the brake actuating signal as an input, and is not limited to that of the electric wiring of FIG. 2 although the brake operation detection switch Bp is shown as a normally-open raising contact point connected in series to a power source 4 of the light emitting device 2 so as to be easy to understand in this embodiment.

In an example of FIG. 2, when the brake is applied by depressing the brake pedal 3, the brake operation detection switch Bp sinks and closes a contact point, and a power source is supplied to the light emitting device 2, and an optical projection image Pi is emitted directly downwardly from the light emitting device 2 to the undersurface of the front of the automobile body 1 as a caution arousing sign.

The optical projection image Pi emitted directly downwardly from the light emitting device 2 as a caution arousing sign is a projection image by means of, for example, a laser beam. The light emitting device 2 emits a laser beam by turning the power source on, and the laser beam is diffused by a lens diffuser panel (not shown), and the resulting diffused light is emitted in a fixed range of the front of the automobile body, and an optical projection image Pi is formed within a specific range on a road. FIG. 1b shows an example in which an optical projection image shaped in an oblong ellipse with respect to the axis O-O of the automobile body 1 is formed at a forward part of the automobile body as a caution arousing sign. The light emitting device 2 is not necessarily limited to the light emitting device that emits a laser beam, and, needless to say, it is desirable to use a device having higher brightness although LEDs, incandescent lamps, etc., can be used.

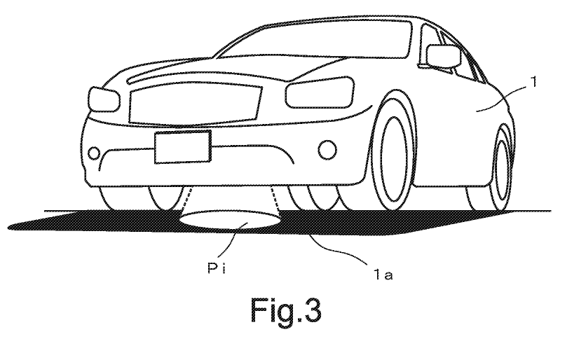

This optical projection image Pi is, for example, a redly luminous projection image. As shown in FIG. 3, a pedestrian looks at an optical projection image Pi displayed in the shadow 1a of the automobile body 1, and ascertains that an automobile driver is correctly performing a brake operation, thus enabling the pedestrian to cross a pedestrian crossing at ease.

By the way, as a real problem, the fact that a pedestrian who is about to cross a road can or cannot ascertain whether an automobile driver is performing a brake operation must be an important problem, and a more convenient situation will be created if it is possible to provide the pedestrian with predictive information about in what state, which includes a stopped state, an automobile is at the present time and about what operation an automobile driver will next perform in actuality.

If a shift lever switching operation and a parking brake application operation, in addition to a depressing operation of the brake pedal, are detected and if a combination of detection signals resulting therefrom is used, it is possible to select a specific caution arousing sign from among prepared caution arousing signs and to project an optical projection image of a caution arousing sign selected therefrom onto the road.

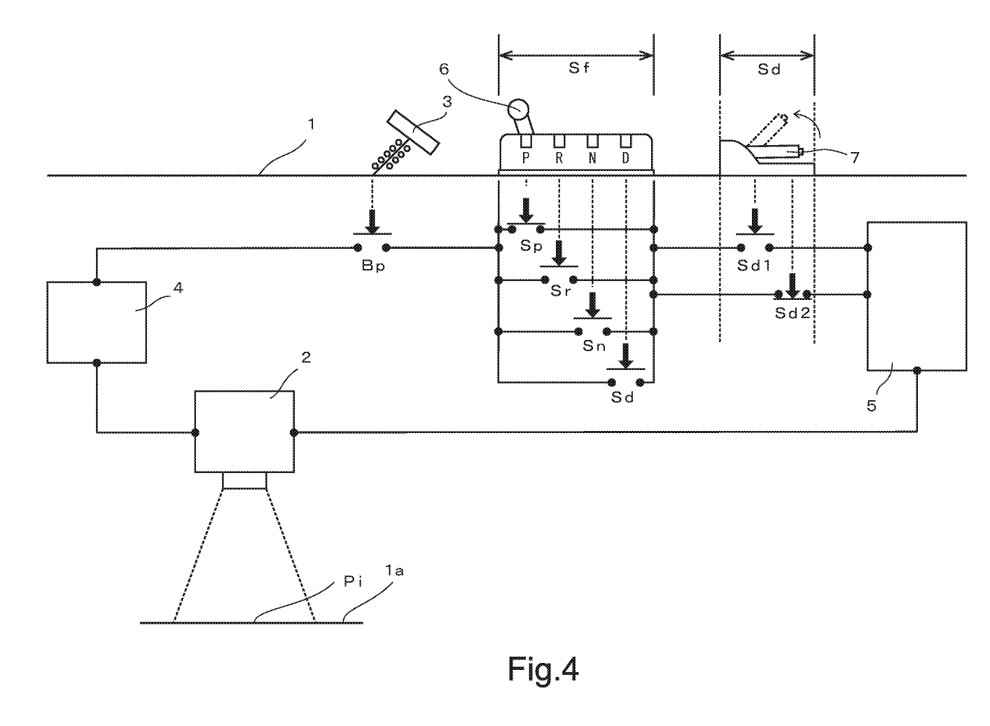

FIG. 4 shows an example in which a caution arousing sign is displayed by combining a shift lever operation and a side lever operation of a transmission of an automatic automobile with a brake operation. This embodiment is composed of the brake operation detection switch Bp, a shift operation detection switch Sf, a parking brake operation detection switch Sd, a controller 5, and the light emitting device 2.

The brake operation detection switch Bp is operated by depressing the brake pedal 3, and outputs a brake actuating signal to the controller 5. Additionally, the shift operation detection switch Sf detects the position of a specific range individually selected by the operation of the shift lever 6, and outputs a position selection signal of a selected range to the controller 5. Still additionally, the parking brake operation detection switch Sd detects the application or release of the parking brake 7, and outputs a parking brake application detection signal to the controller 5.

The controller 5 determines the degree of danger from a combination of a brake actuating signal, a range position selection signal, and a parking brake application detection signal that have been input therefrom, and outputs a determination signal of a luminous color selected from among a plurality of predetermined luminous colors to the light emitting device 2. The light emitting device 2 receives the input of the determination signal from the controller 5, and emits diffused light of the selected luminous color in a fixed range of the front of the automobile body according to the contents of the determination signal, and forms an optical projection image Pi on a road within the range of the shadow of the automobile body as a caution arousing sign.

In FIG. 4, the light emitting device 2 disposed on the undersurface of the front of the automobile body 1 is connected to the power source 4. The controller 5, the brake operation detection switch Bp actuated by the depressing operation of the brake pedal 3, the shift operation detection switch Sf switched by the operation of the shift lever 6, and the parking brake operation detection switch Sd actuated by the parking brake 7 are connected to a power circuit of the light emitting device 2.

If the automobile is an automatic automobile, the shift operation detection switch Sf is composed of switches such as a parking range detection switch Sp switched by the operation of the shift lever 6, a reverse range detection switch Sr, a neutral range detection switch Sn, and a drive range detection switch Sd.

To make sure, positions of ranges switched by the operation of the shift lever 6 are explained as follows. Parking range (P) . . . Position when the automobile is parked, Reverse range (R) . . . Position when the automobile is backed, Neutral range (N) . . . Position where torque from an engine and from a tire to a drive system is interrupted, Drive range (D) . . . Position when the automobile is normally driven. The shift operation detection switches Sf switched by the operation of the shift lever are a (P) range detection switch Sp, an (R) range detection switch Sr, an (N) range detection switch Sn, and a (D) range detection switch Sd that are actuated by being switched between the (P), (R), (N), and (D) ranges.

Herein, to make description comprehensible, an example is shown in which the connection wire of the (P) range detection switch Sp, the connection wire of the (R) range detection switch Sr, the connection wire of the (N) range detection switch Sn, and the connection wire of the (D) range detection switch Sd are wired in parallel with the wire of the brake operation detection switch Bp. The shift lever 6 is switched by the operation of a driver, and therefore, when a specific switch operates while closing a contact point, the other switches are all in a state in which the contact point is open, and two or more contact points are never closed simultaneously.

The parking brake operation detection switch Sd consists of a parking brake application detection switch Sd1 actuated when the parking brake 7 is applied and a parking brake release detection switch Sd2 that detects that the parking brake operation has been released. The parking brake application detection switch Sd1 is shown by a normally-open raising contact point (normally-open contact point), and the parking brake release detection switch Sd2 is shown by a normally-closed raising contact point (normally-closed contact point). The parking brake application detection switch Sd1 and the parking brake release detection switch Sd2 are wired in parallel with each other, and this parallel wiring is connected to the parallel circuit of the shift operation detection switch Sf and to the controller 5.

The reason why the brake operation detection switch Bp, the shift operation detection switch Sf, and the parking brake operation detection switch Sd are each shown by a contact point as described above is that, when two or more switches detect a brake application operation, the position of a range selected by the operation of the shift lever 6, and a parking brake application operation, a combination of the switches that have detected the operations is comprehensibly shown, and this does not denote that a normally-open contact point or a normally-closed contact point is used as the detection switch. The function of the detection switch is to detect the presence or absence of a depressing operation of the brake pedal 3, the switching operation of the shift lever 6, and the presence or absence of the application of the parking brake 7 and is to individually output each detection signal to the controller 5.

Therefore, as described above, the detection signals of the brake operation detection switch Bp, the shift operation detection switch Sf (Sp, Sr, Sn, Sd), and the parking brake operation detection switch Sd (Sd1, Sd2) are individually input to the controller 5, and the controller 5 determines the degree of danger from a combination of input signals, and a determination signal of a luminous color selected from among a plurality of predetermined luminous colors is output to the light emitting device 2 as a caution-arousing-sign display command, and the light emitting device 2 emits diffused light of a luminous color selected therefrom in a fixed range of the front of the automobile body according to the contents of the determination signal, and an optical projection image Pi serving as a caution arousing sign is formed on a road within the range of the shadow of the automobile body 1.

A determination example of a caution arousing sign will be shown below that is emitted by a combination of detection signals of the brake operation detection switch Bp, the shift operation detection switch Sf (Sp, Sr, Sn, Sd), and the parking brake operation detection switch Sd (Sd1, Sd2).

### Example 1

In this example, the brake operation detection switch Bp is in an ON state, the shift operation detection switch Sf (Sd) is in an ON state, and the parking brake operation detection switch Sd is in an ON state and an OFF state (i.e., Sd1 is in an OFF state, and Sd2 is in an ON state).

At this time, the brake is applied by depressing the brake pedal 3, and the shift lever 6 is set at the drive position, and the parking brake 7 is in a state of not being applied. This applies to most cases such as a case in which the automobile travels and then stops at an intersection or short of a pedestrian crossing or a case in which the automobile temporarily stops at a temporary stop line, and, besides, a case in which the automobile stops to avoid danger. In this state, if the depressing of the brake pedal 3 is released, it becomes possible for the automobile to immediately go straight. The controller 5 regards this state as “Caution is required,” and outputs the command of “Caution” to the light emitting device 2. A red optical projection image Pi that serves as a caution arousing sign is projected from the light emitting device 2 to the shadow of the automobile body 1.

### Example 2

In this example, the brake operation detection switch Bp is in an ON state, the shift operation detection switch Sf (Sp) is in an ON state, and the parking brake operation detection switch Sd is in an ON state and an OFF state (i.e., Sd1 is in an ON state, and Sd2 is in an OFF state).

At this time, from the reason that the automobile must be stopped so long as the shift lever 6 selects “Parking” and so long as the parking brake 7 is applied, the controller 5 regards this state as “Safe” and outputs the command of “Safe” to the light emitting device 2. An optical projection image Pi of a luminous color that arouses tentative caution, such as a white or blue luminous color, is projected from the light emitting device 2 to the shadow of the automobile body 1 as a caution arousing sign.

### Example 3

In this example, the brake operation detection switch Bp is in an ON state, the shift operation detection switch Sf (Sp) is in an ON state, and the parking brake operation detection switch Sd is in an OFF state and an ON state (i.e., Sd1 is in an OFF state, and Sd2 is in an ON state).

This example shows a state in which the application of the parking brake 7 has been released from the state of (Example 2). This state is considered as a state of being about to start now, and therefore the controller 5 regards this state as “Caution is required,” and outputs the command of “Urgent warning” to the light emitting device 2. For example, a redly flickering projection image Pi, which indicates an urgent warning, is projected from the light emitting device 2 to the shadow of the automobile body 1 as a caution arousing sign.

### Example 4

In this example, the brake operation detection switch Bp is in an ON state, the shift operation detection switch Sf (Sn or Sr) is in an ON state, and the parking brake operation detection switch Sd is in an ON state and an OFF state (i.e., Sd1 is in an ON state, and Sd2 is in an OFF state).

A state is brought about in which the brake pedal 7 is depressed, and the shift lever 6 selects the neutral range or the reverse range, and the parking brake 7 is applied. From the expectation that the automobile seems not to start forwardly now in this state, the controller 5 regards this state as “Safe,” and outputs the command of “Safe” to the light emitting device 2. An optical projection image Pi of a luminous color that arouses tentative caution, such as a white or blue luminous color, is projected from the light emitting device 2 to the shadow of the automobile body 1 as a caution arousing sign.

### Example 5

When the shift operation detection switch Sf (Sr) is in an ON state and when the parking brake 7 is released, it is determined that the driver will back the automobile, and therefore it is also possible to likewise provide a light emitting device at both side portions or at the rear of the automobile body, if necessary, in order to arouse caution with respect to a pedestrian who crosses in front of the rear of the automobile although it is safe with respect to a pedestrian who crosses in front of the automobile, and possible to project a redly flickering projection image, which indicates an urgent warning, from the light emitting device to the shadow of the automobile body as a caution arousing sign.

Without being limited to the examples of the caution-arousing determination described above, it is possible to provide walking information to pedestrians by creating various pieces of information to predict the action of various drivers by means of a combination of detection signals of the brake operation detection switch Bp, the shift operation detection switch Sf (Sp, Sr, Sn, Sd), and the parking brake operation detection switch Sd (Sd1, Sd2). It is possible to project the optical projection image of each operation not only by optical colors but also by a combination of characters, figures, patterns, symbols, etc.

In any case mentioned above, the projection of a projection image Pi serving as a caution arousing sign from the light emitting device 2 is stopped by stopping the depressing of the brake pedal 3.

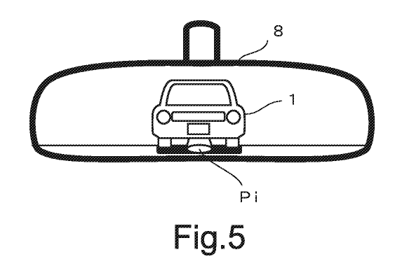

According to the present invention, as shown in FIG. 5, an optical projection image Pi emitted from the light emitting device 2 directly downwardly as a caution arousing sign is reflected in a driving mirror 8 of the automobile that is traveling immediately ahead of a following automobile, and therefore the projection image Pi reflected in the driving mirror 8 enables the driver to easily determine whether the following automobile will be decelerated or will be stopped.

As described above, according to the present invention, it becomes possible to predict an action that will be next performed by an automobile driver from a caution arousing sign issued from the light emitting device by further combining the detection signal of the shift operation detection switch Sf (Sp, Sr, Sn, Sd) and the detection signal of the parking brake operation detection switch Sd (Sd1, Sd2) with the actuating signal of the brake operation detection switch Bp as the caution arousing sign. The present invention is applicable to a manual automobile although the present invention is applied to the automatic automobile in the examples as described above.

### INDUSTRIAL APPLICABILITY

It is possible to provide information about when an automobile is stopped to a pedestrian and hence ensure the safety of the pedestrian and possible to prevent the occurrence of an accident causing injury or death by clearly awakening the pedestrian who crosses in front of or behind the automobile to the fact that an automobile driver is depressing a brake pedal.

### DESCRIPTION OF REFERENCE SIGNS

1: Automobile body, 1a: Shadow, 2: Light emitting device, 3: Brake pedal, 4: Power source, 5: Controller, 6: Shift lever, 7: Parking brake, 8: Driving mirror, Pi: Projection image, Bp: Brake operation detection switch, Sf: Shift operation detection switch, Sd: Parking brake operation detection switch, Sp: Parking range detection switch, Sr: Reverse range detection switch, Sn: Neutral range detection switch, Sd: Drive range detection switch, Sd1: Parking brake application detection switch, Sd2: Parking brake release detection switch

1. A device that displays an operation state of an automobile brake, the device comprising:
a brake operation detection switch; and
a light emitting device,
wherein the brake operation detection switch is actuated by depressing a brake pedal and outputs a brake actuating signal to the light emitting device, and
wherein the light emitting device is disposed on an undersurface of a front of an automobile body, and emits diffused light in a fixed range of the front of the automobile body by receiving an input of the brake actuating signal so as to form an optical projection image oblong with respect to an axis of the automobile body on a road within a range of a shadow of a forward portion of the automobile body as a caution arousing sign.

2. A device that displays an operation state of an automobile brake, the device comprising:
a brake operation detection switch;
a shift operation detection switch;
a parking brake operation detection switch;
a controller; and
a light emitting device,
wherein the brake operation detection switch is actuated by depressing a brake pedal and outputs a brake actuating signal to the controller,
wherein the shift operation detection switch individually detects a position of a specific range selected by operating a shift lever and outputs a position selection signal of a selected range to the controller,
wherein the parking brake operation detection switch detects that a parking brake has been applied or has been released and individually outputs a parking brake application detection signal to the controller,
wherein the controller determines a degree of danger from a combination of the brake actuating signal that has been input, the position selection signal of the range, and the parking brake application detection signal, and outputs a determination signal of a luminous color selected from among a plurality of predetermined luminous colors to the light emitting device, and
wherein the light emitting device is disposed on an undersurface of a front of an automobile body and emits diffused light of a selected luminous color in a fixed range of the front of the automobile body according to contents of the determination signal by receiving an input of the determination signal from the controller so as to form an optical projection image of the selected luminous color on a road within a range of a shadow of the automobile body as a caution arousing sign.
